(19) United States
(12) Patent Application Publication
(10) Pub. No.: US 2020/0292477 A1
(43) Pub. Date: Sep. 17, 2020

(54) NANO-PARTICLE DETECTION OF CHEMICAL TRACE AMOUNTS IN DOWNHOLE NMR FLUID ANALYZER

(71) Applicants: Carl M. Edwards, Katy, TX (US); Stewart Brazil, Houston, TX (US)

(72) Inventors: Carl M. Edwards, Katy, TX (US); Stewart Brazil, Houston, TX (US)

(73) Assignee: Baker Hughes Oilfield Operations LLC, Houston, TX (US)

(21) Appl. No.: 16/353,704

(22) Filed: Mar. 14, 2019

(51) Int. Cl. G01N 24/08; E21B 47/01; E21B 49/08

(52) U.S. Cl. CPC G01N 24/081; E21B 47/01; G01N 24/087; E21B 49/082; E21B 49/081

(57) ABSTRACT

An apparatus for detecting a chemical of interest in a fluid sample includes a sample chamber and a nano-particle injection device configured to inject functionalized magnetic nano-particles and optionally non-functionalized magnetic nano-particles into the fluid sample. The functionalized magnetic nano-particles include a plurality of bits of a reactor chemical spread out and separated from each other over a surface of each of the functionalized magnetic nano-particles for at least one of aggregating and disaggregating the functionalized magnetic nano-particles by binding or reacting to the chemical of interest in the fluid sample and the non-functionalized magnetic nano-particles do not include the plurality of bits. The apparatus also includes a nuclear magnetic resonance (NMR) instrument configured to perform an NMR measurement on the fluid sample having the functionalized magnetic nano-particles to provide first NMR data and a controller configured to detect the chemical of interest using the first NMR data.

### BACKGROUND

Hydrocarbon fluid extracted from a subsurface formation can include trace amounts of one or more chemicals that can cause deleterious effects during hydrocarbon production and processing. Depending on the type of the other chemicals, certain actions may have to be performed before the hydrocarbon fluid can be processed in a refinery. For example, if the hydrocarbon fluid contains hydrogen sulfide, then that hydrocarbon fluid would typically have to be processed by a scrubber to remove the hydrogen sulfide prior to refining. Hence, innovations that improve the detection of trace amounts of chemicals would be well received in the hydrocarbon production industry.

### SUMMARY

Disclosed is an apparatus for detecting a chemical of interest in a fluid sample. The apparatus includes: a sample chamber configured to contain the fluid sample; a nano-particle injection device configured to inject functionalized magnetic nano-particles and optionally non-functionalized magnetic nano-particles into the fluid sample in the sample chamber, wherein the functionalized magnetic nano-particles comprise a plurality of bits of a reactor chemical spread out and separated from each other over a surface of each of the functionalized magnetic nano-particles for at least one of aggregating and disaggregating the functionalized magnetic nano-particles by binding or reacting to the chemical of interest in the fluid sample and the non-functionalized magnetic nano-particles do not include the plurality of bits; a nuclear magnetic resonance (NMR) instrument configured to perform an NMR measurement on the fluid sample having the functionalized magnetic nano-particles in the sample chamber to provide first NMR data; and a controller configured to detect the chemical of interest using the first NMR data.

Also disclosed is a method for detecting a chemical of interest in a fluid sample. The method includes: injecting functionalized magnetic nano-particles into the fluid sample in a sample chamber, wherein the functionalized magnetic nano-particles comprise a plurality of bits of a reactor chemical spread out and separated from each other over a surface of each of the functionalized magnetic nano-particles for at least one of aggregating and disaggregating the functionalized magnetic nano-particles by binding or reacting to the chemical of interest in the fluid sample; performing a nuclear magnetic resonance (NMR) measurement on the fluid sample having the functionalized magnetic nano-particles in the sample chamber using an NMR instrument to provide first NMR data; and detecting the chemical of interest using the first NMR data.

### BRIEF DESCRIPTION OF THE DRAWINGS

The following descriptions should not be considered limiting in any way. With reference to the accompanying drawings, like elements are numbered alike:

FIG. 1 illustrates a cross-sectional view of a logging system for detecting a chemical in a fluid in a borehole penetrating a subsurface formation;

FIG. 2 depicts aspects of a logging tool having a fluid analyzer;

FIG. 3 illustrates a cross-sectional view of using the fluid analyzer to monitor a stream of hydrocarbons flowing in a conduit;

FIG. 4 illustrates a cross-sectional view of a functionalized magnetic nano-particle configured to bind with the chemical of interest;

FIGS. 5A and 5B, collectively referred to as FIG. 5, illustrate an effect of a thiol containing hydrocarbon compound on aggregation of 10 to 20 nm magnetic nano-particles in toluene;

FIGS. 6A-6C, collectively referred to as FIG. 6, depict aspects of using Alizarin-3-sulfonic acid to detect hydrogen sulfide;

FIGS. 7A and 7B, collectively referred to as FIG. 7, depict aspects of using C₁₃H₁₁N₃S to detect Hg⁺² ions by aggregation of magnetic nano-particles;

FIG. 8 illustrates a cross-sectional view of a non-functionalized nano-particle that is not configured to bind with the chemical of interest;

FIG. 9 depicts aspects of functionalized nano-particles binding with an element or molecule of the chemical of interest; and

FIG. 10 is a flow chart for a method for detecting a chemical of interest in a fluid sample comprising a hydrocarbon.

### DETAILED DESCRIPTION

A detailed description of one or more embodiments of the disclosed apparatus and method are presented herein by way of exemplification and no limitation with reference to the Figures.

Disclosed are apparatuses and methods for detecting a chemical of interest in a fluid sample. The apparatuses and methods involve extracting a sample of a hydrocarbon fluid from subsurface formations or other hydrocarbon streams. The fluid sample is injected with functionalized magnetic nano-particles that are configured to either aggregate into or disaggregate from clusters or groups upon binding or reacting with the chemical of interest. Functionalized magnetic nano-particles that are configured to aggregate upon binding with the chemical of interest causes forward magnetic relaxation switching that can be quantified by performing an NMR experiment or measurement on the fluid sample to provide first NMR data. The aggregating causes increased magnetic field inhomogeneity and, thus, shortens the NMR relaxation time (e.g., transverse relaxation time T₂). By comparing the first NMR data to reference NMR data that was obtained by performing an NMR measurement on the fluid sample with non-functionalized magnetic nano-particles that do not bind to the chemical of interest, the chemical of interest can be identified. Alternatively, functionalized magnetic nano-particles that are already pre-aggregated into clusters may be injected into the fluid sample and then disaggregate from the clusters by reacting to the chemical of interest. The disaggregating causes reverse magnetic relaxation switching by decreasing the magnetic field inhomogeneity and, thus, lengthens the NMR relaxation time. In the disaggregating embodiment, the reference NMR data for comparison may be obtained immediately after injection of the disaggregating magnetic nano-particles before a significant amount of them can react with the chemical of interest.

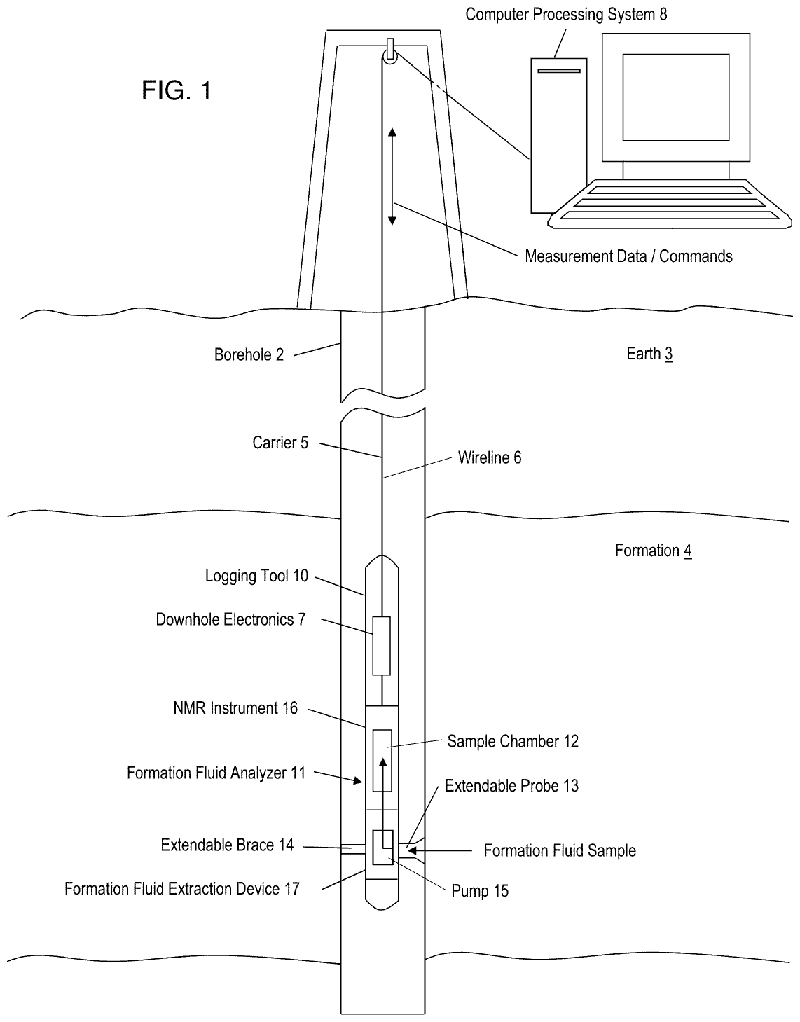

FIG. 1 illustrates a cross-sectional view of a logging tool 10 disposed in a borehole 2 penetrating the earth 3 having a geologic formation 4. The formation 4 includes a formation fluid that may include a chemical of interest such as hydrogen sulfide in a non-limiting embodiment. The logging tool 10 is supported and conveyed through the borehole 2 by a carrier 5. In an operation referred to as wireline logging, the carrier 5 is an armored wireline 6. In addition to supporting the logging tool 10, the wireline 6 can be used to supply electrical power and to communicate data and commands between the logging tool 10 and a surface computer processing system 8 disposed at the surface of the earth 3. Downhole electronics 7 disposed on the logging tool 10 are configured to operate the tool 10 and/or provide a communications interface with the surface computer processing system 8. Operating, controlling, and/or processing functions may be divided between the downhole electronics 7 and the surface computer processing system 8 or they may overlap to provide redundancy.

In another operation referred to as logging-while-drilling (LWD) or measurement-while-drilling (MWD), the carrier 5 is a drill tubular such as a drill string or coiled tubing. In this operation, the logging tool 10 is conveyed through the borehole 2 while the borehole 2 is being drilled. In LWD/MWD, the logging tool 10 may perform an operation or measurement during a temporary halt in drilling.

The logging tool 10 includes a formation fluid analyzer 11 that is configured to extract a sample of a fluid from a wall of the borehole 2 and analyze the fluid sample to detect if the chemical of interest is present in the fluid sample. The formation fluid analyzer includes a formation fluid extraction device 17 that is configured to extract the fluid sample from the wall of the borehole 2 and deposit the fluid sample in a sample chamber 12. The formation fluid extraction device 17 includes an extendable probe 13 that is configured to extend from the tool 10 and seal with the wall of the borehole 2. An optional extendable brace 14 is configured to extend from the tool 10 and brace the tool 10 against the borehole wall to allow the probe 13 to seal to the borehole wall. A pump 15 in fluid communication with the probe 13 is configured to lower the pressure internal to the probe 13 in order to draw the fluid sample from the formation 4 and deposit it in the sample chamber 12. It can be appreciated that the fluid analyzer 11 may be configured as a standalone tool or it may be configured as a module that may be incorporated into an existing downhole tool.

The logging tool 10 also includes an NMR instrument 16 that is configured to perform NMR experiments or measurements on the fluid sample in the sample chamber 12. Output from an NMR measurement includes a relaxation time such as a longitudinal relaxation time T₁, transverse relaxation time T₂, and/or the relaxation time of the free-induction decay T₂* as known in the art. In general, there is not one single value of T₁ or T₂ for fluids being characterized, but a wide distribution of values lying anywhere between fractions of a millisecond (ms) and several seconds for example. The distributions of T₁ and T₂ values may serve as primary inputs for identifying the chemical of interest. Identification of the presence of the chemical of interest in formation fluid may be correlated to a depth into the formation at which the fluid sample was obtained, and together may be referred to as a chemical detection log.

The NMR instrument 16 may include various components known in the art such as a static magnetic field source, a transmitter antenna for transmitting a sequence of radio-frequency (RF) pulses that temporarily aligns protons is a certain direction or directions, and a receiver antenna for receiving NMR signals such as echo-trains due to precession of protons in the static magnetic field. The transmitter antenna (or coils) transmit precisely timed bursts of radio-frequency energy to excite the spins. In a time period between these pulses, the receiver antenna (or coils) receive an NMR signal from those protons (or nuclei of interest) that are on-resonance with the static magnetic field produced by the static magnetic field source. In some instances the receiver antenna and the transmitter antenna may be the same antenna. The NMR instrument 16 may also include processing electronics for recording the received NMR signals such as spin echoes and processing theta to obtain the T₁ and T₂, and T₂* relaxation times or relaxation time distributions. It can be appreciated that the NMR instrument 16 may include a variety of components and configurations known in the art of NMR. Consequently, specific details of those NMR components, configurations, sequences of transmitter pulses, and processing schemes known in the art are not discussed in further detail.

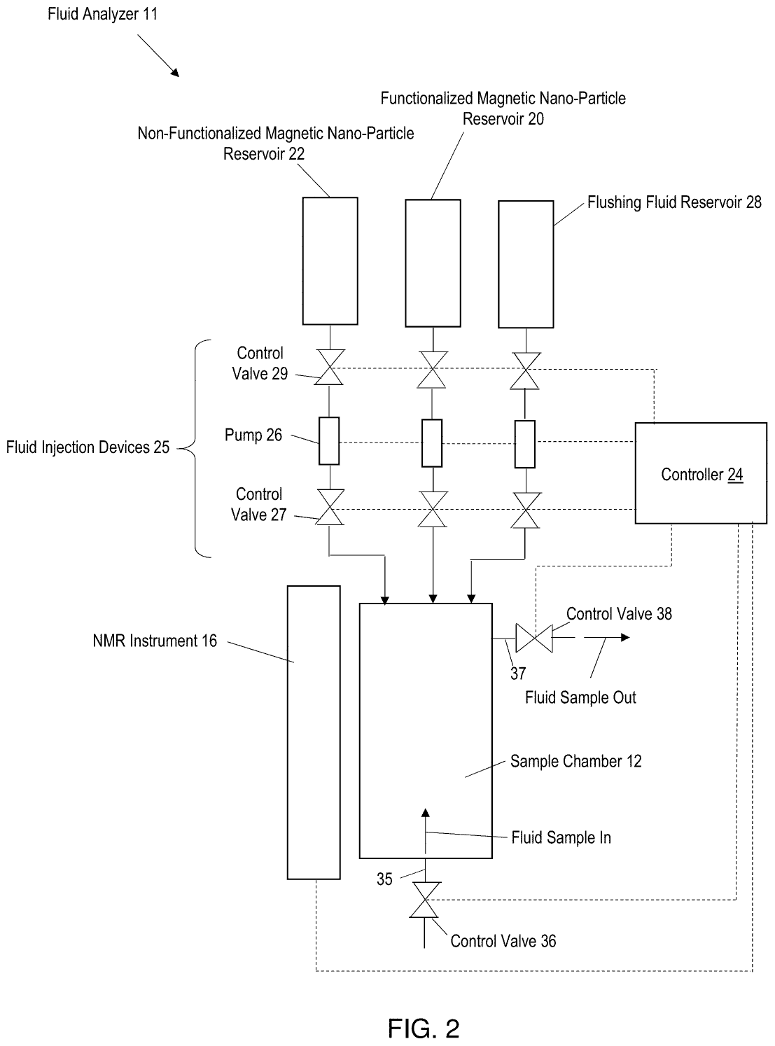

FIG. 2 depicts aspects of the formation fluid analyzer 11. The formation fluid analyzer 11 includes a functionalized magnetic nano-particle reservoir 20 and optionally a non-functional magnetic nano-particle reservoir 22. The functionalized magnetic nano-particle reservoir 20 is configured to contain functionalized magnetic nano-particles 21 and to inject a certain or defined amount of the functionalized magnetic nano-particles 21 into the sample chamber 12 upon command by a controller 24, which may be implemented by the downhole electronics 7. The functionalized magnetic nano-particles 21 may be of the type that aggregate upon reacting with the chemical of interest or the type that is pre-aggregated and disaggregate upon reacting with the chemical of interest. The non-functionalized magnetic nano-particle reservoir 22 is configured to contain non-functionalized magnetic nano-particles 23 and to inject a certain or defined amount of the non-functionalized magnetic nano-particles 21 into the sample chamber 12 upon command by the controller 24. The formation fluid analyzer 11 may also include a flushing fluid reservoir 28 containing a flushing fluid (e.g., distilled water and/or decane) to flush the sample chamber 12 of the fluid sample before a new fluid sample is deposited in the sample chamber 12. Alternatively, the fluid sample may be flushed by flowing formation fluid through the sample chamber 12. Fluid injection devices 25 such as a pump 26, a control valve 27, and an optional control valve 29 may be used to inject the functionalized magnetic nano-particles 21, the non-functionalized magnetic nano-particles 23, and the flushing fluid. The sample chamber 12 may include an inlet 35 having a control valve 36 to control fluid entering the sample chamber 12 and an outlet 37 having a control valve 38 to control fluid exiting the sample chamber 12. The controller 24 may be used to control the pump 26, the control valve 27, the control valve 29, the control valve 36, the control valve 38, and process NMR data received from the NMR instrument 16.

It can be appreciated that multiple fluid samples may be obtained at various depths to provide a log of detected chemicals of interest. Further, different types of the chemicals of interest may be detected by using different types of functional nano-particles 21 where each type of nano-particle 21 is functionalized to react with a certain type of chemical of interest. In this case, the functional nano-particle reservoir 20 may represent multiple functional nano-particle reservoirs with each reservoir containing a different type of functional nano-particle 21 that is functionalized for a corresponding specific chemical of interest.

It can also be appreciated that the sample chamber 12, control valves 27, pump 26, and optional control valve 29 can all be integrated individually, collectively, or partially into a microfluidics platform. This is particularly relevant to the use of the device in a downhole environment because of the reduction in size of the fluid analyzer 11 that may be obtained using microfluidics. It reduces the size of many of the components especially the reservoirs 22, 20 and 28.

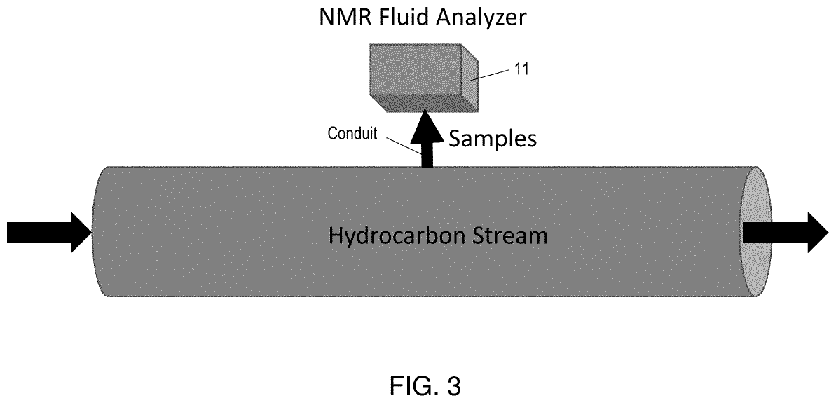

It can further be appreciated that the fluid analyzer 11 can be used to monitor a stream of hydrocarbons, which may be flowing in a pipe as illustrated in FIG. 3. In this application, the fluid analyzer 11 is connected to the hydrocarbon stream and periodically collects samples. Once collected the analyzer injects them with magnetic nano-particles, makes NMR relaxation measurements, and analyzes the results in accordance with the techniques disclosed herein. Once the fluid analysis process is completed, the fluid analyzer 11 discards the current fluid sample in preparation for receiving the next fluid sample.

It can be appreciated that the fluid sample may contain multiple immiscible fluid phases such as formation water and formation hydrocarbons. Thus, it can be advantageous to configure the fluid sample inlet 35 to have two or more inlets that can sample the fluid stream independently. These inlets may be configured to be hydrophobic or hydrophilic. Hydrophobic inlets will selectively permit the hydrocarbon phase to flow while blocking the formation water phase. Hydrophilic inlets will select just the formation water phase.

Hydrophobic inlets may be produced by coating the inlet with chemicals such as Fluorinated silanes or Fluoropolymer coatings. Teflon is one such fluoropolymer but there are many other examples of chemicals that can produce a hydrophobic coating. Hydrophilic inlets may be produced by coating the inlet with chemicals that contain hydroxyl (—OH) groups. Hydroxyl groups are polar and attract water molecules. One such polymer is manufactured by Gellner Industrial with a product name Ottopol 523.

Coating the inlets is particularly relevant to a configuration that uses a microfluidic platform. The passage ways in this configuration are very small such that the capillary pressure of the fluids makes the fluid phase separation very easy to do. In alternate configurations, the coatings may be applied to membranes that cover the inlets to perform the separation.

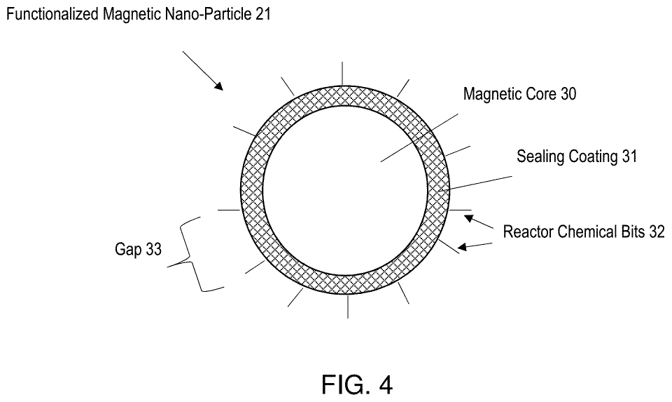

FIG. 4 illustrates a cross-sectional view of one functionalized magnetic nano-particle 21 configured to bind with the chemical interest. In one or more embodiments, the functionalized magnetic nano-particle 21 has a diameter or dimension in a range of 10-20 nanometers. The functionalized nano-particle 21 includes a magnetic core 30. The magnetic core 30 may be made of any type of material that can be magnetized such as iron oxide in a non-limiting embodiment. The functionalized magnetic nano-particle 21 also includes a sealing coating 31 directly over the magnetic core 30. The sealing coating 31 is configured to seal the magnetic core 30 to prevent degradation of the magnetic core 30 such as through oxidation in a non-limiting example. An example of one such coating is polyethylene glycol better known as PEG. A sealing coating may not be needed provided the nano-particle material does not degrade in the presence of the sample fluid, chemical reactor bits can be attached, and is soluble in the sample fluid. Disposed over the sealing coating 31 are reactor chemical bits 32 that are “sprinkled” or spread out onto the sealing coating 31 such that the chemical bits have a specific surface density. The surface density is such that it creates a space or a gap 33 between each of the bits 32. The reactor chemical bits 32 are illustrated as “hairs” protruding from the sealing coating 32 in FIG. 3. The reactor chemical bits 32 are configured to react with the chemical of interest. The gap 33 is to allow one functionalized magnetic nano-particle 21 to bind with the chemical of interest without taking up an additional binding location or feature, thus, allowing another functionalized magnetic nano-particle 21 to also bind to the chemical of interest to provide for aggregation of the functionalized magnetic nano-particles 21 into clusters. In one or more embodiments, the binding location or feature relates to an electron vacancy. For example, if the chemical of interest has two electron vacancies, then it is desired to have only one fimctionalized magnetic nano-particle 21 bind to the chemical of interest using only one of the electron vacancies, thus, allowing another functionalized magnetic nano-particle 21 to also bind to the chemical of interest. Other types of binding reactions that cause the functionalized magnetic nano-particles to aggregate may also be used.

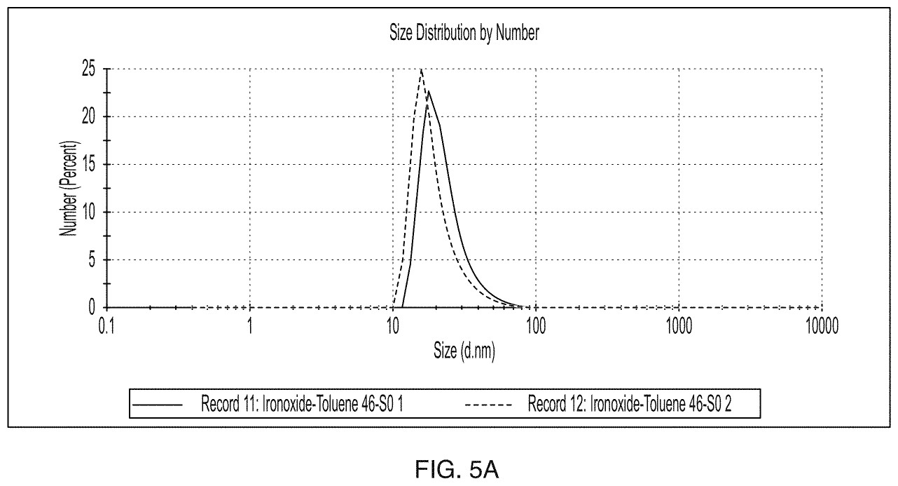

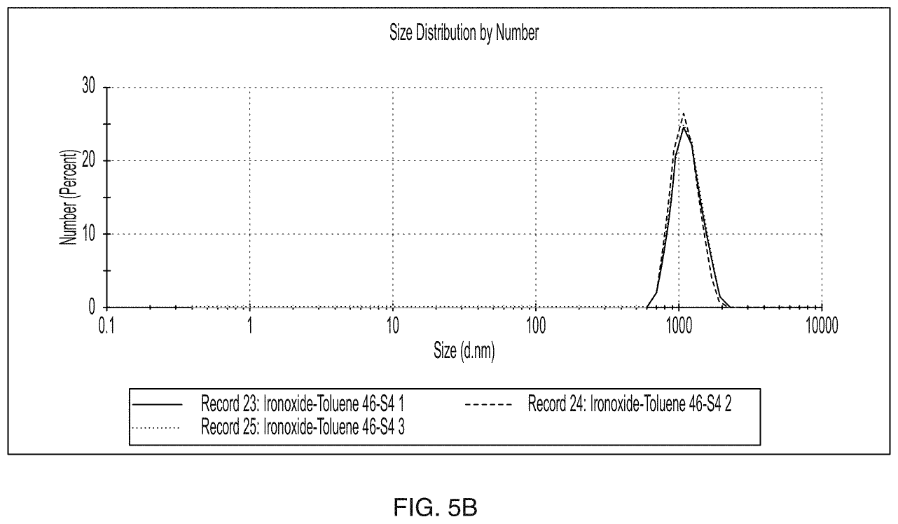

A commercial nano-particle that is already functionalized is manufactured by the Ferrotec Corporation, a globally recognized company. It is called EMG 1400 and its surfactant or chemical bits are hydrophobic. It is soluble in hydrocarbons and has been shown to aggregate in the presence of thiol containing compounds in toluene. FIG. 5 illustrates an effect of a thiol containing hydrocarbon compound on aggregation of 10 to 20 nm magnetic nano-particles in toluene. The results of light scattering results are shown in FIG. 5 and demonstrate aggregation in the presence of thiol containing compounds. FIG. 5A illustrates a light scattering measurement of size distribution of functionalized magnetic nano-particles in toluene, while FIG. 5B illustrates a light scattering measurement of size distribution of functionalized magnetic nano-particles in the presence of trace amounts of thiol containing compound 4-mercaptobenzoic acid in toluene.

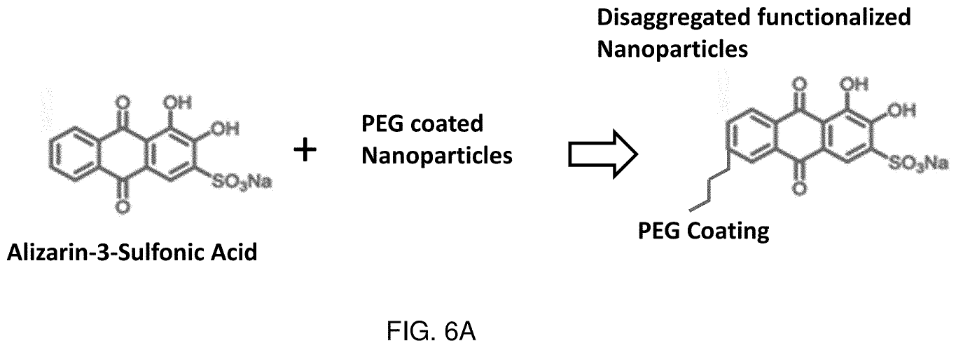

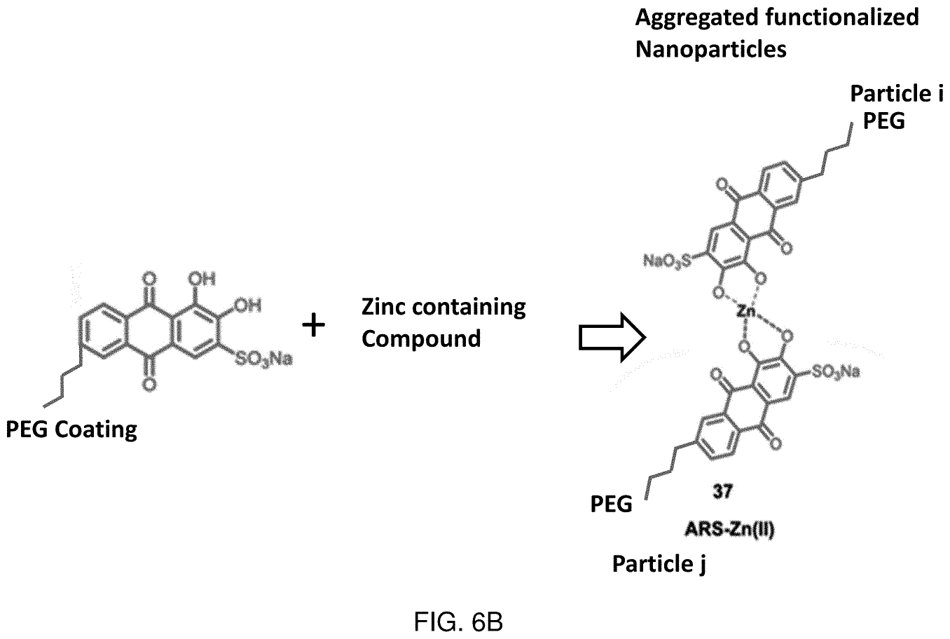

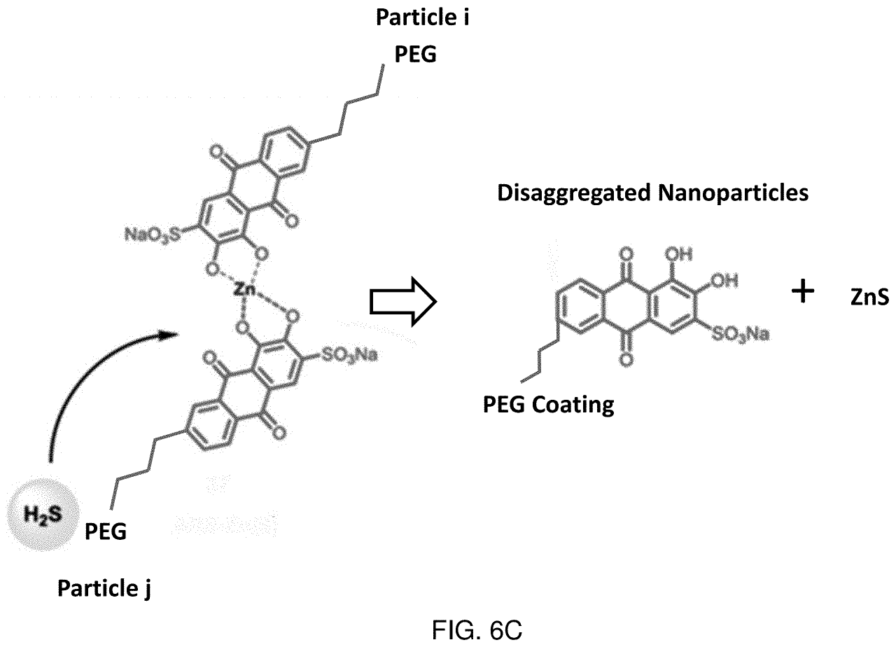

An example of a nano-particle functionalization that uses disaggregation to increase relaxation times is shown in FIG. 6. Here the chemical, alizarin-3-sulfonic acid, is reacted to attach it to a nano-particle surface coating such as PEG to attach it to its surface such as with a straight-chain hydrocarbon as shown in FIG. 6A. Other methods of attaching it to the surface coating may also be used. The method of reacting alizarin-3-sulfonic acid may also be different for different types of surface coatings.

The density of locations where the Alizarin-3-sulfonic acid is attached to the surface coating will be sparse if the concentration of Alizarin-3-sulfonic acid is sufficiently dilute. The functionalized nano-particles are then placed in a chemical bath and reacted with a Zinc containing compound to produce an analogue of ARS-Zn (II) as shown in FIG. 6B. if the surface density of the locations of functionalization is sufficiently sparse, the analogue of ARS-Zn (II) must necessarily be formed between two different nano-particles. “Analogue” here means a chemical similar to the one in question but has the same reactivity to the chemical of interest. The attachment of the functionalizing chemical changes the chemical, and that attachment however should not change the new chemical or analogue reactivity to the chemical of interest. In general, the appropriate amount of functionalization, the amounts of Alizarin-3-sulfonic acid, the Zinc containing compound, and the amounts and types of additional chemicals in the reaction chain may be tuned in a laboratory based upon the specific materials and chemicals being used. Different reaction chains may be needed for other types of surface coatings.

When the aggregated nano-particles are injected into a sample containing H₂S, then the H₂S reacts with the Zinc to form zinc sulfide and nano-particles are disaggregated as shown in FIG. 6C. The nano-particles remain aggregated when the sample does not contain H₂S and disaggregate when the sample contains H₂S. This is an example of using aggregated magnetic nano-particles, which disaggregate in the presence of a chemical of interest, to detect the chemical of interest and is not to be construed as limiting this method to the specific functionalization or the specific chemical of interest.

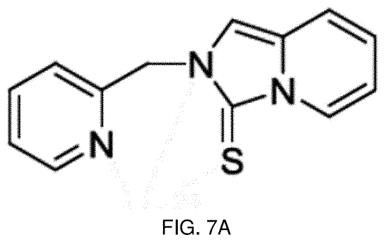

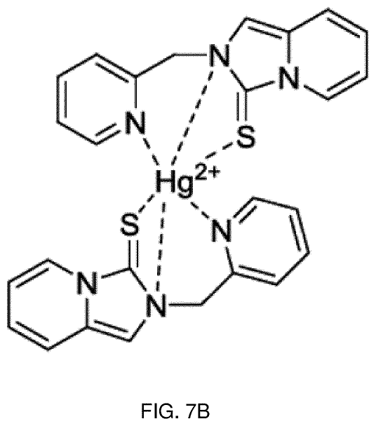

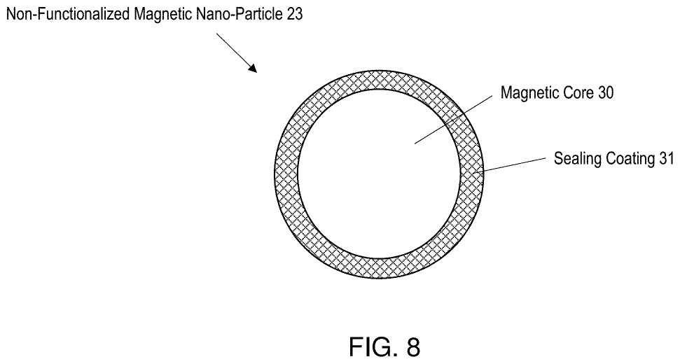

FIG. 7 depicts aspects of using C₁₃H₁₁N₃S to detect Hg⁺² ions by aggregation of magnetic nano-particles. FIG. 7A shows the chemical structure of an isomer of C₁₃H₁₁N₂S. Functionalizing magnetic nano-particles with this chemical by attaching it with a straight-chain hydrocarbon is a non-limiting example of using originally disaggregated nano-particles that aggregate in the presence of a chemical constituent of interest. In this case the chemical of interest is doubly ionized mercury, Hg⁺². In the presence of the Hg⁺², ligand bonds are created between two of the chemical bits attached to the nano-particles as shown in FIG. 7B. Thus, the nano-particles become aggregated. In general, the surface concentration of the chemical bits may be tuned in a laboratory to facilitate aggregation of the nano-particles in the presence of the chemical of interest.

FIG. 1 depicts aspects of one non-functionalized magnetic nano-particle 23. Similar to the functionalized magnetic nano-particles 21, the non-functionalized magnetic nano-particles 23 also has a diameter or dimension in a range of 10-20 nanometers. The non-functionalized magnetic nano-particles 23 also includes the magnetic core 30 and the sealing coating 31. However, the non-functionalized magnetic nano-particles 23 do not include the reactor chemical bits 32 and, thus, are not configured to react with the chemical of interest. Rather, the non-functionalized magnetic nano-particles 23 are used to provide reference NMR data against which future NMR measurements using the functionalized magnetic nano-particles 21 can be compared.

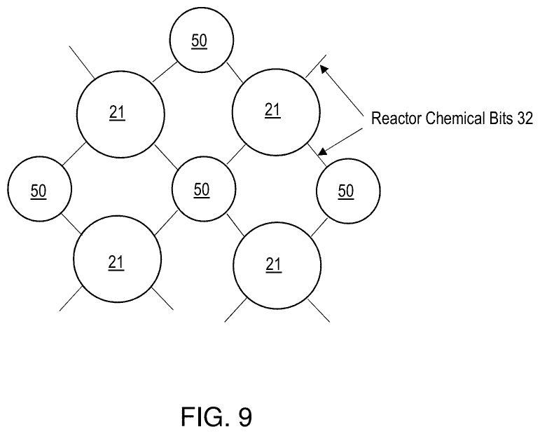

FIG. 9 depicts aspects of the functionalized magnetic nano-particles 21 binding with the chemical of interest 50, which may be an atom or molecule. As illustrated in FIG. 9, multiple functionalized nano-particles 21 may bind to one atom or more molecules of the chemical of interest 50, thus, forming a cluster of functionalized magnetic nano-particles 21.

The cluster has increased magnetization, that causes an indication of the clustering which can be detected by the NMR instrument 16, thus, indicating detection of the chemical of interest. Alternatively, the functionalized nano-particles 21 can be pre-aggregated into clusters in the functional magnetic nano-particle reservoir 20. Upon injection into the sample chamber 12, these pre-aggregated functionalized magnetic nano-particles 31 will react with the chemical of interest thereby spreading out and dis-aggregating the clusters and changing the magnetization of the sample. The change in magnetization can be detected by the NMR instrument 16, thus, indicating detection of the chemical of interest. Magnetic nano-particles in a fluid are superparamagnetic. Every nanoparticle's magnetization aligns along an applied external magnetic field, such as required to perform NMR measurements. Each magnetic nanoparticle creates a dipole magnetic field. The field of a magnetic dipole decreases as 1/r³ (where r=radius) from the center of the magnetic dipole. Thus, there exists a substantial magnetic field gradient near the nanoparticle. It is proportional to the magnetic moment of the magnetic nano-particle. It increases the width of the static magnetic field distribution and as a result decreases T₂*. In addition, as fluid molecules diffuse in this field gradient, they experience a time-varying magnetic field. This results in a decrease in the relaxation time, T₂, as it is known in the art, when compared to bulk fluid relaxation times without magnetic nano-particles. The magnitude of the decreases in T₂ and T₂* depends on the NMR instrument 16, the number density of the nano-particles, and the techniques used to measure the relaxation time.

When magnetic nano-particles are aggregated, they combine to form larger superparamagnetic particles. They also align along applied magnetic fields. However, in this case, the magnetic dipole moment of the aggregated cluster is much larger than any single nanoparticle. Therefore, the width of the static magnetic field distribution is larger than the dispersed case. Consequently, the decrease in T₂* is larger. Also, as the fluid molecules diffuse in and out of the much larger magnetic field gradient, the decrease in the relaxation time is much larger compared to the decrease in the relaxation time in fluids with dispersed magnetic nano-particles.

The chemical of interest is detected by measuring a relaxation time or relaxation time distribution in a first sample with functionalized nano-particles. A second sample of the same fluid stream may be injected with dispersed non-functionalized magnetic nano-particles. The chemical of interest is detected by comparing these relaxation times or distributions, or by comparing the first relaxation time or distribution with a calibration. The samples are extracted from the fluid stream sequentially and rapidly, thereby assuring that both samples have the same constituents. Alternatively, a large sample may be taken from the fluid stream and the samples to be measured are taken from this larger sample to ensure uniform concentrations of the samples' constituent chemicals.

The NMR instrument 16 can be calibrated in a laboratory to correlate a change in output of the NMR instrument 16 with a known chemical of interest using the appropriate functionalized magnetic nano-particles 21 (either the type that aggregates upon chemical reaction or the pre-aggregated type that disaggregates upon chemical reaction) and, optionally, the non-functionalized magnetic nano-particles 22.

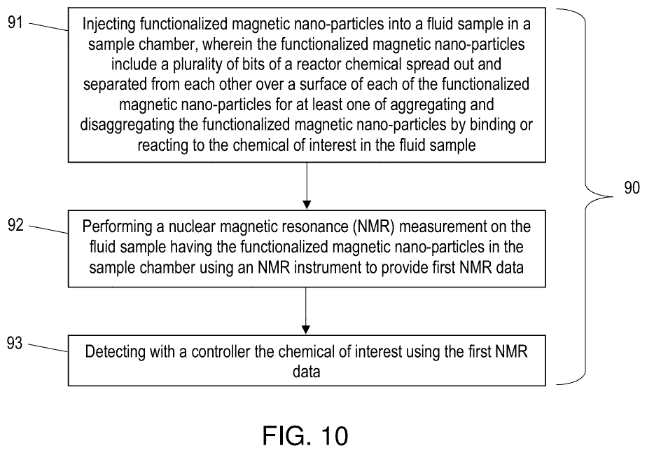

FIG. 10 is a flow chart for a method 90 for detecting a chemical of interest in a fluid sample. In one or more embodiments, the fluid sample contains a single phase fluid. In one or more embodiments, the fluid is a hydrocarbon. Block 91 calls for injecting functionalized magnetic nano-particles into the fluid sample in the sample chamber, wherein the functionalized magnetic nano-particles include a plurality of bits of a reactor chemical spread out and separated from each other over a surface of each of the functionalized magnetic nano-particles for at least one of aggregating and disaggregating the functionalized magnetic nano-particles by binding or reacting to the chemical of interest in the fluid sample. Block 92 calls for performing a nuclear magnetic resonance (NMR) measurement on the fluid sample having the functionalized magnetic nano-particles in the sample chamber using an NMR instrument to provide first NMR data. Block 93 calls for detecting with a controller the chemical of interest using the first NMR data.

The method 90 may also include determining a difference between the first NMR data and reference NMR data and identifying the chemical of interest based on the difference. In one or more embodiments, the chemical of interest may be determined based on the difference exceeding a threshold value that may take into account measurement noise so as not to have a false indication.

The method 90 may also include injecting non-functionalized magnetic nano-particles in another sample of the same type of fluid and performing an NMR measurement on that fluid sample having the non-functionalized magnetic nano-particles to provide the reference NMR data, wherein the non-functionalized magnetic nano-particles do not include the plurality of bits.

The method 90 may also include injecting the functionalized magnetic nano-particles that are configured to disaggregate by binding to the chemical of interest into another sample of the same type of fluid but without the presence of the chemical of interest and performing a reference NMR measurement on that fluid sample having aggregated clusters of the functionalized magnetic nano-particles to provide the reference NMR data.

The method 90 may also include (a) extracting the fluid sample from a subsurface formation using a fluid extraction device disposed on a carrier configured to be conveyed through a borehole penetrating the subsurface formation and (b) disposing the fluid sample in a sample chamber disposed on the carrier.

The method 90 may also include at least one of displaying and recording a signal comprising information indicating detection of the chemical of interest. The displaying may be implemented using a display monitor or printed matter viewed by a user.

The method 90 may also include permitting a hydrocarbon phase of the fluid sample to flow into the sample chamber while blocking or limiting a water phase of the fluid sample from flowing into the sample chamber using an inlet to the sample chamber coated with a hydrophobic chemical.

The method 90 may also include permitting a water phase of the fluid sample to flow into the sample chamber while blocking or limiting a hydrocarbon phase of the fluid sample from flowing into the sample chamber using an inlet to the sample chamber coated with a hydrophilic chemical.

The disclosure herein provides several advantages. One advantage is that due the sensitivity of the NMR instrument 16 it can provide for detecting a trace amount of the chemical of interest that would not normally be detectable. Another advantage is that it also saves time by providing for detection in a borehole, thus, not having to obtain a sample downhole and then send the sample to a laboratory for testing. When used in for a hydrocarbon stream in a chemical plant (e.g. refinery), treatment and processing decisions can be made in near real-time that minimize damage to plant facilities caused by the chemical contaminants as well as optimize processing parameters to improve the output of the processing stream.

Set forth below are some embodiments of the foregoing disclosure:

Embodiment 1. An apparatus for detecting a chemical of interest in a fluid sample, the apparatus comprising: a sample chamber configured to contain the fluid sample; a nano-particle injection device configured to inject functionalized magnetic nano-particles and optionally non-functionalized magnetic nano-particles into the fluid sample in the sample chamber, wherein the functionalized magnetic nano-particles comprise a plurality of bits of a reactor chemical spread out and separated from each other over a surface of each of the functionalized magnetic nano-particles for at least one of aggregating and disaggregating the functionalized magnetic nano-particles by binding or reacting to the chemical of interest in the fluid sample and the non-functionalized magnetic nano-particles do not include the plurality of bits; a nuclear magnetic resonance (NMR) instrument configured to perform an NMR measurement on the fluid sample having the functionalized magnetic nano-particles in the sample chamber to provide first NMR data; and a controller configured to detect the chemical of interest using the first NMR data.

Embodiment 2. The apparatus according to any prior embodiment, wherein the fluid sample comprises a hydrocarbon and the apparatus further comprises a sample conduit coupling the sample chamber to a hydrocarbon stream.

Embodiment 3. The apparatus according to any prior embodiment, further comprising: a carrier configured to be conveyed through a borehole penetrating a subsurface formation, wherein the sample chamber, the nano-particle injection device, and the NMR instrument are disposed on the carrier; and a fluid extraction device disposed on the carrier and configured to extract the fluid sample from the subsurface formation.

Embodiment 4. The apparatus according to any prior embodiment, wherein the carrier comprises at least one of a drill string, a wireline, a slick line, and coiled tubing.

Embodiment 5. The apparatus according to any prior embodiment, wherein the controller is configured to determine a difference between the first NMR data and reference NMR data for the chemical of interest and to identify the chemical of interest based on the difference.

Embodiment 6. The apparatus according to an prior embodiment, wherein the reference NMR data results from injecting the non-functionalized magnetic nano-particles into the fluid sample and the first NMR data results from injecting the functionalized magnetic nano-particles that aggregate by binding with of the chemical of interest.

Embodiment 7. The apparatus according to any prior embodiment, wherein the reference NMR data results from injecting functionalized magnetic nano-particles that are pre-aggregated when injected into the sample chamber and the first NMR data results from the pre-aggregated magnetic nano-particles disaggregating by reacting with the chemical of interest.

Embodiment 8. The apparatus according to claim any prior embodiment, wherein each of the functionalized magnetic nano-particles comprises a core of a magnetic material having a single magnetic domain and/or each or the non-functionalized magnetic nano-particles comprises a core of a magnetic material having a single magnetic domain.

Embodiment 9. The apparatus according to any prior embodiment, wherein the core of the functionalized magnetic nano-particles comprises iron oxide and/or the core of the non-functionalized magnetic nano-particles comprises iron oxide.

Embodiment 10. The apparatus according to any prior embodiment, wherein the core of the functionalized magnetic nano-particles and/or the core of the non-functionalized magnetic nano-particles comprises a sealing coating configured to seal the core to prevent oxidation or degradation.

Embodiment 11. The apparatus according to any prior embodiment, wherein the sealing coating comprises polyethylene glycol.

Embodiment 12. The apparatus according to any prior embodiment, wherein the chemical coating is configured to (a) aggregate the functionalized nano-particles upon binding to the chemical of interest or (b) aggregate the functionalized nano-particles into clusters prior to injection and disaggregate the clusters upon reacting with the chemical of interest.

Embodiment 13. The apparatus according to any prior embodiment, wherein the plurality of bits is configured to aggregate the functionalized nano-particles upon binding to the chemical of interest comprises C₁₃H₁₁N₂S.

Embodiment 14. The apparatus according to any prior embodiment, wherein the plurality of bits is configured to aggregate the functionalized nano-particles into clusters prior to injection and disaggregate the clusters upon reacting with the chemical of interest comprises Alizarin-3-sulfonic acid.

Embodiment 15. The apparatus according to any prior embodiment, wherein the chemical of interest comprises hydrogen sulfide.

Embodiment 16. The apparatus according to any prior embodiment, further comprising at least one of a display configured to display a signal comprising information indicating detection of the chemical of interest and a recording device configured to record the signal.

Embodiment 17. The apparatus according to any prior embodiment, further comprising an inlet to the sample chamber, the inlet being coated with a hydrophobic chemical configured to permit a hydrocarbon phase of the fluid sample to flow into the sample chamber while blocking or limiting a water phase of the fluid sample from flowing into the sample chamber.

Embodiment 18. The apparatus according to any prior embodiment, further comprising an inlet to the sample chamber, the inlet being coated with a hydrophilic chemical configured to permit a water phase of the fluid sample to flow into the sample chamber while blocking or limiting a hydrocarbon phase of the fluid sample from flowing into the sample chamber.

Embodiment 19. A method for detecting a chemical of interest in a fluid sample, the method comprising: injecting functionalized magnetic nano-particles into the fluid sample in a sample chamber, wherein the functionalized magnetic nano-particles comprise a plurality of bits of a reactor chemical spread out and separated from each other over a surface of each of the functionalized magnetic nano-particles for at least one of aggregating and disaggregating the functionalized magnetic nano-particles by binding or reacting to the chemical of interest in the fluid sample; performing a nuclear magnetic resonance (NMR) measurement on the fluid sample having the functionalized magnetic nano-particles in the sample chamber using an NMR instrument to provide first NMR data; and detecting the chemical of interest using the first NMR data.

Embodiment 20. The method according to any prior embodiment, wherein the detecting comprises determining a difference between the first NMR data and reference NMR data and identifying the chemical of interest based on the difference.

Embodiment 21. The method according to any prior embodiment, further comprising injecting non-functionalized magnetic nano-particles into another sample of the same type of fluid and performing an NMR measurement on that fluid sample having the non-functionalized magnetic nano-particles to provide the reference NMR data, wherein the non-functionalized magnetic nano-particles do not include the plurality of bits.

Embodiment 22. The method according to any prior embodiment, further comprising injecting the functionalized magnetic nano-particles that are configured to disaggregate by reacting to the chemical of interest into another sample of the same type of fluid but without the presence of the chemical of interest and performing a reference NMR measurement on that fluid sample having aggregated clusters of the functionalized magnetic nano-particles to provide the reference NMR data.

Embodiment 23. The method according to any prior embodiment, further comprising at least one of displaying and recording a signal comprising information indicating detection of the chemical of interest.

Embodiment 24. The method according to any prior embodiment, further comprising: extracting the fluid sample from a subsurface formation using a fluid extraction device disposed on a carrier configured to be conveyed through a borehole penetrating the subsurface formation; and disposing the fluid sample into the sample chamber.

Embodiment 25, The method according to any prior embodiment, further comprising permitting a hydrocarbon phase of the fluid sample to flow into the sample chamber while blocking or limiting a water phase of the fluid sample from flowing into the sample chamber using an inlet to the sample chamber coated with a hydrophobic chemical.

Embodiment 26. The method according to any prior embodiment, further comprising permitting a water phase of the fluid sample to flow into the sample chamber while blocking or limiting a hydrocarbon phase of the fluid sample from flowing into the sample chamber using an inlet to the sample chamber coated with a hydrophilic chemical.

In support of the teachings herein, various analysis components may be used, including a digital and/or an analog system. For example, the downhole electronics 7, computer processing system 8, logging tool 10, the NMR instrument 16, and/or the controller 24 may include a digital and/or analog system. The system may have components such as a processor, storage media, memory, input, output, communications link (wired, wireless, optical or other), user interfaces (e.g., a display and/or printer), software programs, signal processors (digital and/or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer-readable medium, including memory (ROMs, RAMs), optical (CD-ROMs), or magnetic (disks, hard drives), or any other type that when executed causes a computer to implement the method of the present invention, These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

The term “carrier” as used herein means any device, device component, combination of devices, media and/or member that may be used to convey, house, support or otherwise facilitate the use of another device, device component, combination of devices, media and/or member. The logging tool 10 is one non-limiting example of a carrier. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” and the like are intended to be inclusive such that there may be additional elements other than the elements listed. The conjunction “or” when used with a list of at least two terms is intended to mean any term or combination of terms. The term “configured” relates one or more structural limitations of a device that are required for the device to perform the function or operation for which the device is configured. The term “first” and the like do not denote a specific order but are used to distinguish elements.

The flow diagram depicted herein is just an example. There may be many variations to this diagram or the steps (or operations) described therein without departing from the spirit of the invention. For instance, the steps may be performed in a differing order, or steps may be added, deleted or modified. All of these variations are considered a part of the claimed invention.

The disclosure illustratively disclosed herein may be practiced in the absence of any element which is not specifically disclosed herein.

While one or more embodiments have been shown and described, modifications and substitutions may be made thereto without departing from the scope of the invention. Accordingly, it is to be understood that the present invention has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An apparatus for detecting a chemical of interest in a fluid sample, the apparatus comprising:
a sample chamber configured to contain the fluid sample;
a nano-particle injection device configured to inject functionalized magnetic nano-particles and optionally non-functionalized magnetic nano-particles into the fluid sample in the sample chamber, wherein the functionalized magnetic nano-particles comprise a plurality of bits of a reactor chemical spread out and separated from each other over a surface of each of the functionalized magnetic nano-particles for at least one of aggregating and disaggregating the functionalized magnetic nano-particles by binding or reacting to the chemical of interest in the fluid sample and the non-functionalized magnetic nano-particles do not include the plurality of bits;
a nuclear magnetic resonance (NMR) instrument configured to perform an NMR measurement on the fluid sample having the functionalized magnetic nano-particles in the sample chamber to provide first NMR data; and
a controller configured to detect the chemical of interest using the data.

2. The apparatus according to claim 1, wherein the fluid sample comprises a hydrocarbon and the apparatus further comprises a sample conduit coupling the sample chamber to a hydrocarbon stream.

3. The apparatus according to claim 1, further comprising:
a carrier configured to be conveyed through a borehole penetrating a subsurface formation, wherein the sample chamber, the nano-particle injection device, and the NMR instrument are disposed on the carrier; and
a fluid extraction device disposed on the carrier and configured to extract the fluid sample from the subsurface formation.

4. The apparatus according to claim 3, wherein the carrier comprises at least one of a drill string, a wireline, a slick line, and coiled tubing.

5. The apparatus according to claim 1, wherein the controller is configured to determine a difference between the first NMR data and reference NMR data for the chemical of interest and to identify the chemical of interest based on the difference.

6. The apparatus according to claim 5, wherein the reference NMR data results from injecting the non-functionalized magnetic nano-particles into the fluid sample and the first NMR data results from injecting the functionalized magnetic nano-particles that aggregate by binding with of the chemical of interest.

7. The apparatus according to claim 5, wherein the reference NMR data results from injecting functionalized magnetic nano-particles that are pre-aggregated when injected into the sample chamber and the first NMR data results from the pre-aggregated magnetic nano-particles disaggregating by reacting with the chemical of interest.

8. The apparatus according to claim 1, wherein each of the functionalized magnetic nano-particles comprises a core of a magnetic material having a single magnetic domain and/or each or the non-functionalized magnetic nano-particles comprises a core of a magnetic material having a single magnetic domain.

9. The apparatus according to claim 8, wherein the core of the functionalized magnetic nano-particles comprises iron oxide and/or the core of the non-functionalized magnetic nano-particles comprises iron oxide.

10. The apparatus according to claim 9, wherein the core of the functionalized magnetic nano-particles and/or the core of the non-functionalized magnetic nano-particles comprises a sealing coating configured to seal the core to prevent oxidation or degradation.

11. The apparatus according to claim 10, wherein the sealing coating comprises polyethylene glycol.

12. The apparatus according to claim 10, wherein the chemical coating is configured to (a) aggregate the functionalized nano-particles upon binding to the chemical of interest or (b) aggregate the functionalized nano-particles into clusters prior to injection and disaggregate the clusters upon reacting with the chemical of interest.

13. The apparatus according to claim 12, wherein the plurality of bits is configured to aggregate the functionalized nano-particles upon binding to the chemical of interest comprises C₁₃H₁₁N₂S.

14. The apparatus according to claim 12, wherein the plurality of bits is configured to aggregate the functionalized nano-particles into clusters prior to injection and disaggregate the clusters upon reacting with the chemical of interest comprises Alizarin-3-sulfonic acid.

15. The apparatus according to claim 1, wherein the chemical of interest comprises hydrogen sulfide.

16. The apparatus according to claim 1, further comprising at least one of a display configured to display a signal comprising information indicating detection of the chemical of interest and a recording device configured to record the signal.

17. The apparatus according to claim 1, further comprising an inlet to the sample chamber, the inlet being coated with a hydrophobic chemical configured to permit a hydrocarbon phase of the fluid sample to flow into the sample chamber while blocking or limiting a water phase of the fluid sample from flowing into the sample chamber.

18. The apparatus according to claim 1, further comprising an inlet to the sample chamber, the inlet being coated with a hydrophilic chemical configured to permit a water phase of the fluid sample to flow into the sample chamber while blocking or limiting a hydrocarbon phase of the fluid sample from flowing into the sample chamber.

19. A method for detecting a chemical of interest in a fluid sample, the method comprising:
injecting functionalized magnetic nano-particles into the fluid sample in a sample chamber, wherein the functionalized magnetic nano-particles comprise a plurality of bits of a reactor chemical spread out and separated from each other over a surface of each of the functionalized magnetic nano-particles for at least one of aggregating and disaggregating the functionalized magnetic nano-particles by binding or reacting to the chemical of interest in the fluid sample;
performing a nuclear magnetic resonance (NMR) measurement on the fluid sample having the functionalized magnetic nano-particles in the sample chamber using an NMR instrument to provide first NMR data; and
detecting the chemical of interest using the first NMR data.

20. The method according to claim 19, wherein the detecting comprises determining a difference between the first NMR data and reference NMR data and identifying the chemical of interest based on the difference.

21. The method according to claim 20, further comprising injecting non-functionalized magnetic nano-particles into another sample of the same type of fluid and performing an NMR measurement on that fluid sample having the non-functionalized magnetic nano-particles to provide the reference NMR data, wherein the non-functionalized magnetic nano-particles do not include the plurality of bits.

22. The method according to claim 20, further comprising injecting the functionalized magnetic nano-particles that are configured to disaggregate by reacting to the chemical of interest into another sample of the same type of fluid but without the presence of the chemical of interest and performing a reference NMR measurement on that fluid sample having aggregated clusters of the functionalized magnetic nano-particles to provide the reference NMR data.

23. The method according to claim 19, further comprising at least one of displaying and recording a signal comprising information indicating detection of the chemical of interest.

24. The method according to claim 19, further comprising:
extracting the fluid sample from a subsurface formation using a fluid extraction device disposed on a carrier configured to be conveyed through a borehole penetrating the subsurface formation; and
disposing the fluid sample into the sample chamber.

25. The method according to claim 19, further comprising permitting a hydrocarbon phase of the fluid sample to flow into the sample chamber while blocking or limiting a water phase of the fluid sample from flowing into the sample chamber using an inlet to the sample chamber coated with a hydrophobic chemical,

26. The method according to claim 19, further comprising permitting a water phase of the fluid sample to flow into the sample chamber while blocking or limiting a hydrocarbon phase of the fluid sample from flowing into the sample chamber using an inlet to the sample chamber coated with a hydrophilic chemical.
